(19) United States
(12) Patent Application Publication
(10) Pub. No.: US 2007/0036376 A1
(43) Pub. Date: Feb. 15, 2007

(54) Earphones

(76) Inventor: Lance Fried, San Diego, CA (US)

Correspondence Address: STETINA BRUNDA GARRED & BRUCKER, 75 ENTERPRISE, SUITE 250, ALISO VIEJO, CA, 92656, US

(21) Appl. No.: 11/583,307

(22) Filed: Oct. 19, 2006

Related U.S. Application Data
(63) Continuation-in-part of application No. 11/222,163, filed on Sep. 8, 2005.
(60) Provisional application No. 60/608,586, filed on Sep. 10, 2004.

(51) Int. Cl. H04R 25/00

(52) U.S. Cl. 381/312

(57) ABSTRACT

An earphone is provided wherein the earphone may be secured to the user while engaging in vigorous water related or non-water related sports such that the user may both listen to audio programming and engage in the physical activity. In particular, the earphone may have a deformable structure which is adjustably securable to the ear of the user. The earbud of the earphone may be attached to the deformable structure via the electrical wire connecting the speaker and the jack of the earphone. Once the deformable structures are secured to the ears of the user, a cinching device may be tightened so as to create tension in the electrical wires to hold the earphone to the head of the user. Additionally, the deformable structure due to its deformability is comfortable to wear. Additionally, the ear interface member of the earbud of the earphone may be fabricated from a soft material and be interchangeable with the housing of the earbud such that an appropriate sized ear interface member may be attached to the housing.

### CROSS-REFERENCE TO RELATED APPLICATIONS

This application is a continuation in part application of U.S. patent application Ser. No. 11/222,163, filed Sep. 8, 2005 which claims the benefits of U.S. Prov. Pat. App. Ser. No. 60/608,586, filed Sep. 9, 2004. The entire contents of U.S. patent application Ser. No. 11/222,163 and U.S. Prov. Pat. App. Ser. No. 60/608,586 are incorporated herein by reference.

### STATEMENT RE: FEDERALLY SPONSORED RESEARCH/DEVELOPMENT

Not Applicable

### BACKGROUND

The present invention relates to an earphone which may be sufficiently secured to a user's head such that the user may simultaneously listen to audio programming and engage in normal daily or vigorous physical activity.

Active people, hikers, surfers, snowboarders and the like, enjoy listening to music and other audio programs while engaging in normal daily or vigorous physical activities which may include the risk or inevitability of being wet. One method for the participant to listen to his/her favorite music while engaged in the vigorous physical activity is to listen to a compact disc. However, a CD player has many inherent problems such as weight, track skipping and size. Additionally, for snowboarding and swimming (i.e., water related sports), participants cannot listen to music with CD players because CD players are not water resistant or waterproof. Moreover, CD players are typically too large and too heavy for the active person to carry the CD player while participating in the vigorous physical activity.

Another impediment or problem which prevents active people from listening to their favorite audio programming while engaged in vigorous physical activity is the loose engagement of the earphone to the user's head. In particular, prior art earphones do not sufficiently engage the user's head such that the user may listen to his/her favorite audio programming and maneuver his/her body as required in the vigorous physical activity. Larger earphones, such as those that are embedded in a helmet may be sufficiently secured to the user's head, but the helmet is too bulky for the user to engage in certain vigorous physical activity. For example, the user may have to twist his or her head to scan his or her surrounding while engaged in the vigorous physical activity. The bulky helmet would interfere with the user's required movement. Additionally, the bulky helmet would be uncomfortable to wear in warm weather. In compact prior art earphones, the engagement of the earphone to the user's head may not be sufficient. The earphones may be dislodged from the user's head as the user moves as required by the vigorous physical activity. For example, in surfing, the surfer must duck under the wave to let the wave pass him or her as the user proceeds beyond the break point of the waves. Unfortunately, water passing by the user's ears will dislodge the prior art earphone. Another problem with prior art earphones is that the earbuds may dangle and interfere with the user's enjoyment of the vigorous physical activity when the ear buds are dislodged from the user's ears. The ear buds are also hard to find when dislodged from the user's ears.

### BRIEF SUMMARY

The various aspects of the earphones discussed herein addresses the needs above, discussed below and those that are known in the art. The earphones provide one or more methods of securing the earphone to the user. In particular, the earphone may comprise earbuds, electrical wires, deformable structures, a clip and a jack. The earbuds may be secured to the ears of the user via a semi-customizable ear interface member. When the user purchases the earphones, the earphone may be provided with different sized sets of ear interface members, for example, a small set of ear interface members, medium set of ear interface members and a large set of ear interface members. The user may use the correct or appropriate fitting sized ear interface members such that the ear interface member is sufficiently frictionally engaged to the ear canal of the user but not too small so as to be too loose (i.e., not sufficiently engaged to user's ear) or too large so as to be too tight (i.e., uncomfortable). The earbuds may be electrically connected to the electrical wires and in electrical communication with the jack. Each of the electrical wires may be secured to a deformable structure which may be secured to the ears of the user. The deformable structures may be placed over the user's ears and traversed to a closed position such that the deformable structure is sufficiently secured to the user's ear in that the deformable structure will not dislodge from the user's ear when the user is engaged in the vigorous physical activity. The distance between the earbud of the earphone and the deformable structure may be adjusted such that the earbud may then be properly inserted into the ear canal of the user. The distance between the earbud and the deformable structure may be sufficiently short such that if the earbud were to be dislodged from the ear of the user, the earbud would be easy to find. The user need only raise his or her hand adjacent or in close proximity to the user's ear to find the earbud because the ear bud is tethered to the deformable structure. The clip may be attached to the electrical wires. While the earphones are in use, the clip may be attached to the body of the user.

After the deformable structures are secured to the user's ears, a cinching device slidingly attached to the electrical wires may be slid up and lock below the user's lower jaw. By way of example and not limitation, the cinching device may be locked via frictional engagement. The cinching device applies tension in the electrical wires to hold the deformable structure in place despite vigorous movement required by the vigorous physical activity.

The earphones provide one to three levels (i.e., deformable structure, ear interface member and cinching device) of securing the earphone to the user such that the user may feel confident that the earphones will remain attached to the user despite the required movement of the user in the participation of the vigorous physical activity. Moreover, the earphone is not dislodged from the user's head even though the ear bud may be dislodged from the user's ear because the deformable structure is secured to the user's ear.

The earphone is also comfortable to wear. In particular, the ear interface member, discussed above, may be fabricated from a soft pliable material. It may also have a high coefficient of friction with respect to the skin of the user. The deformable structure may also be fabricated from a soft malleable material such that the deformable structure does not poke the user around the ear.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an illustration of an earphone;

FIG. 2 is a cross-sectional view of an earbud of the earphone shown in FIG. 1;

FIG. 3 is an enlarged view of the earbud and a deformable structure adjustably attached to each other via an electrical wire;

FIG. 3A is a cross-sectional view of the deformable structure and electrical wire shown in FIG. 3; and

FIG. 4 is a perspective view of the earphone when inserted into an ear of the user.

### DETAILED DESCRIPTION

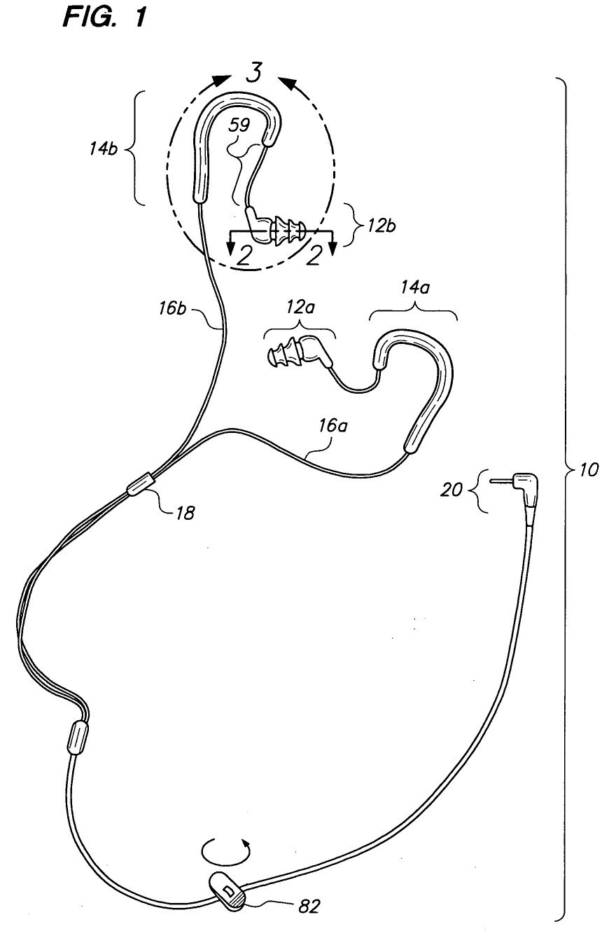

Referring now to FIG. 1, an earphone 10 is illustrated which may be comfortably secured to a user's head such that the user may engage in vigorous physical activity and yet be able to listen to his/her favorite audio program (e.g., music, audio books, etc.). The earphone 10 will be described in this application in relation water sports such as surfing, swimming and the like but it is also contemplated that the earphone 10 may be employed in other non-water related daily activities and sports such as running, tennis, etc. Three features of the earphone 10 which allow the earphone 10 to be comfortably secured to the user's head will be discussed herein as well as other features. One or more of the three features may be variously embodied and employed in the earphone 10 as desired in different combinations. All three features are not required to be simultaneously employed in the earphone 10. Also, other features of the earphone 10 which allow the earphone 10 to be comfortably secured to the user's head are also discussed herein.

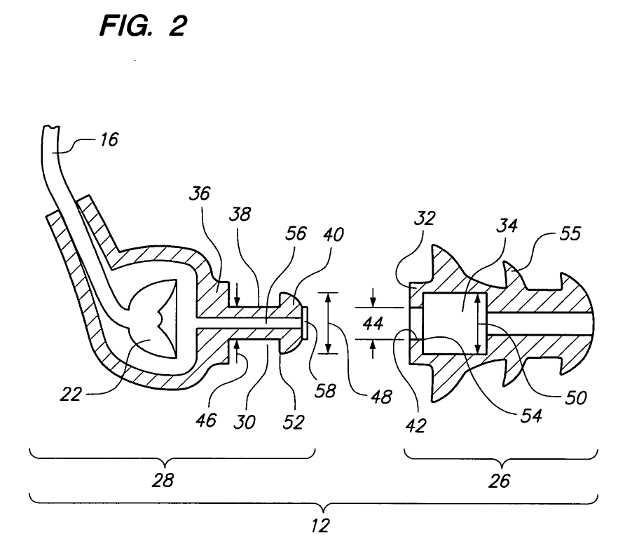

The earphone 10 may comprise left and right earbuds 12a, 12b, left and right deformable structures 14a, 14b, left and right electrical wires 16a, 16b, a cinching device 18, and a jack 20. The left and right earbuds 12a, 12b are connected to the left and right electrical wires 16a, 16b, respectively. Also, the electrical wires 16 are electrically connected to the jack 20. When the jack 20 is inserted into an output jack 20 of an audio producing machine (e.g., MP3 player), the jack 20 picks up electrical signals from the audio producing machine and transmits the same to speakers 22 (see FIG. 2) within the earbuds 12 that translates the electrical signals to audible sounds such that the user may listen to the same.

The earphone 10 is comfortable to wear due to a semi-customized ear interface member 26 (see FIG. 2). For example, when the user purchases the earphones 10, the earphones 10 may be provided with a plurality (e.g., three) of sets of ear interface members 26 of differing sizes, such as small, medium and large. The user may try on the small, medium or large sized ear interface member 26 to determine which ear interface member 26 provides the most comfort. The ear interface member 26 should not be too loose in the user's ear such that the earbud 12 will not dislodge from the user's ear during physical activity or too tight so as to be uncomfortable. Based on the user's ear size/preference, the appropriate set of ear interface members 26 may be attached to housings 28 of the earbuds 12. In particular, a first set of ear interface members 26 may be attached to the housings 28 of the ear bud 12. If the first set of ear interface members is too small or too large, then the first set of ear interface members 26 may be removed from the housings 28 and a second or third set of ear interface members 26 may be attached to the housing 28 depending on which set of ear interface members 26 most comfortably fits the user's ear and is sufficiently retainable in the user's ear despite vigorous movement of the user.

The ear interface member 26 may be removably attachable to the housing 28, as shown in FIG. 2 and as follows. The rigid housing 28 may have an undercut groove 30 which is sized and configured to mate with a lip 32 and an inner cavity 34 of the ear interface member 26. In particular, a distal portion of the rigid housing 28 may have a base 36, stem 38 and retaining member 40. The base 36 supports the ear interface member 26 when the ear interface member 26 is attached to the rigid housing 28. The stem 38 receives an inner periphery 42 of the lip 32 of the ear interface member 26. Lastly, the retaining member 40 is inserted into the enlarged cavity 34 of the ear interface member 26. The lip 32 of the ear interface member 26 and the retaining member 40 resists disengagement of the ear interface member 26 from the rigid housing 28. Preferably, an inner diameter 44 of the lip 32 of the ear interface member 26 is equal to an outer diameter 46 of stem 38. The outer diameter 48 of the retaining member 40 is preferably equal to an inner diameter 50 of the enlarged cavity 34 of the ear interface member 26. More preferably, an outer peripheral edge 52 of the retaining member 40 has a minimal radius or a sharp edge. Also, an inner peripheral edge 54 of the lip 32 has a minimal radius or sharp edge. These features assist in resisting disengagement between the ear interface member 26 and the housing 28.

When the ear interface member 26 is attached to the rigid housing 28, the junction between the stem 38 and the retaining member 40 is sized and configured to receive the inner peripheral edge 54. Also, the junction between the lip 32 and the enlarged cavity wall is sized and configured to mate with the outer peripheral edge 52 of the retaining member 40. Such close mating configuration provide optimal disengagement resistance between the ear interface member 26 and the rigid housing 28. Moreover, the inner diameter 44 of the lip 32 and the enlarged cavity 34 of the ear interface member 26 may be sized and configured to snuggly fit over the stem 38 and retaining member 40 of the rigid housing 28 to sufficiently secure the two interchangeable parts such that they will not come apart under normal use.

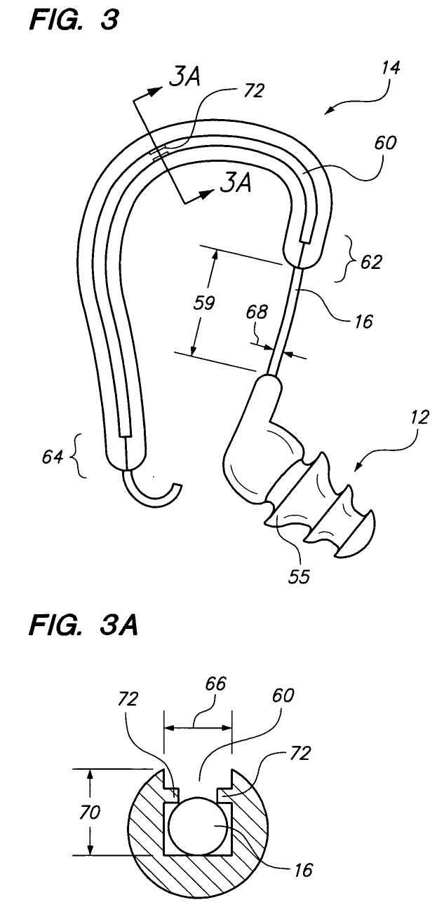

The ear interface member 26 may have outwardly extending ridges 55 (see FIGS. 2 and 3). The outwardly extending ridges 55 of the ear interface member 26 engages the inner surface of the ear canal. In particular, the ear interface member may have three outwardly extending ridges 55. Each of the outwardly extending ridges 55 may have a successively enlarging outer diameter. These outwardly extending ridges 55 may also be shaped so as to lean toward the housing 28 of the ear bud 12. To insert the ear bud 12 into the ear canal of the user, the distal end of the ear interface member 26 is first inserted into the ear canal of the user. The outer diameter of the first outwardly extending ridge 55 may be smaller than an inner diameter of the ear canal of the user. If so, then the middle outwardly extending ridge 55 may be sufficiently large so as to be greater than an inner diameter of the ear canal of the user. In this manner, the middle ridge 55 and the third outwardly extending ridge 55 frictionally engages the surface of the ear canal of the user. Due to the cone-shaped configuration of each of the ridges 55, the earbud 12 may be easy to insert and more difficult to dislodge compared to the force required to insert the earbud 12 into the ear canal of the user. Alternatively, if the middle ridge 55 is smaller than the inner diameter of the ear canal of the user, the third ridge 55 must be sufficiently large so as to frictionally engage the ear canal of the user. Otherwise, a larger ear interface member 26 must be used or attached to the housing 28.

The ear interface member 26 may be fabricated from a flexible material such as rubber which springs back to its original shape after being deformed and released. The rigid housing 28 may be fabricated from a hard plastic such as polypropylene, ABS, polyurethane, silicon etc. The material of the rigid housing 28 and the ear interface member 26 may be selected to have a high coefficient of friction between the rigid housing 28 and the ear interface member 26 such that the ear interface member 26 may not be easily pulled off of the rigid housing 28.

The earphone 10 discussed herein may be used while the user is engaged in a water sport activity. To this end, the speaker 22 (see FIG. 2) in the rigid housing 28 may optionally be coated with a waterproof coating. Additionally, as shown in FIG. 2, a sound passageway 56 through the rigid housing 28 may be covered with a flexible member 58 which is waterproof to allow sounds to be projected to the user's eardrums but yet prevent water from entering the rigid housing 28 and contacting the speakers 22. The electrical wire 16 projecting from the rigid housing 28 may be sealed against the rigid housing 28 such that water may not enter the rigid housing 28 through the opening for the electrical wire 16.

An enlarged view of the deformable structure 14 is shown in FIGS. 3 and 3A. The deformable structure 14 may have a J-shaped configuration which may be manipulated, sized and configured to fit around the front of the user's ear, wrap above and behind the user's ear. The deformable nature of the deformable structure 14 adds a level of comfort to use of the earphone 10. The deformable structure 14 may be twisted and bent to conform to the base of the user's ear. The deformable structure 14 may be malleable such that after the deformable structure 14 is disposed about the user's ear, the user may reduce the size of the deformable structure 14 to pinch the user's ear and secure the deformable structure 14 to the user's head. The deformable structure 14 may be fabricated from the following types of materials: silicon, polyurethane, nylon, PVS, adjustable metal, etc. These materials allow the deformable structure 14 to hold a certain shape after the user has bent or twisted the deformable structure 14 against the user's ear.

The deformable structure 14 may be attached to the electrical wire 16 and also permit the earbud 12 to be placed at an adjustable distance 59 to the deformable structure 14. The adjustability of the distance 59 between the deformable structure 14 and the ear bud 12 permits the ear bud 12 to be insertable into the ear of the user but short enough such that if the ear bud 12 were to be dislodged from the user's ear then the ear bud 12 would not interfere with the user's required motion for the physical activity in which the user is participating. Also, the ear bud 12 would be easy to find. The user need only feel around the user's ear for the ear bud 12 and not visually look for the dislodged ear bud 12.

The distance 59 between the deformable structure 14 and ear bud 12 may be made adjustable as follows. In particular, the deformable structure 14 may have an elongate channel 60 formed therethrough. The elongate channel 60 extends from a first distal portion 62 to a second distal portion 64 of the deformable structure 14. The channel 60 may be sized and configured to frictionally receive the electrical wire 16. In particular, as shown in FIG. 3A, a width 66 of the channel 60 may be equal to a diameter 68 of the electrical wire 16. Also, a height 70 of the channel 60 may be greater than a diameter 68 of the electrical wire 16. The electrical wire 16 may be retained within the channel 60 by covering the channel 60 at the first and second distal portions 62, 64 of the deformable structure 14. Additionally, nubs 72 may be placed along the channel interior to hold the electrical wire 16 in the channel 60. The distance 59 between the earbud 12 and the deformable structure 14 may be adjusted by sliding the electrical wire 16 through the channel 60 of the deformable structure 14. Because the wire is frictionally fitted within the channel 60, the length of the electrical wire 16 from the deformable structure 14 to the earbud 12 does not enlarge or shorten once adjusted during use.

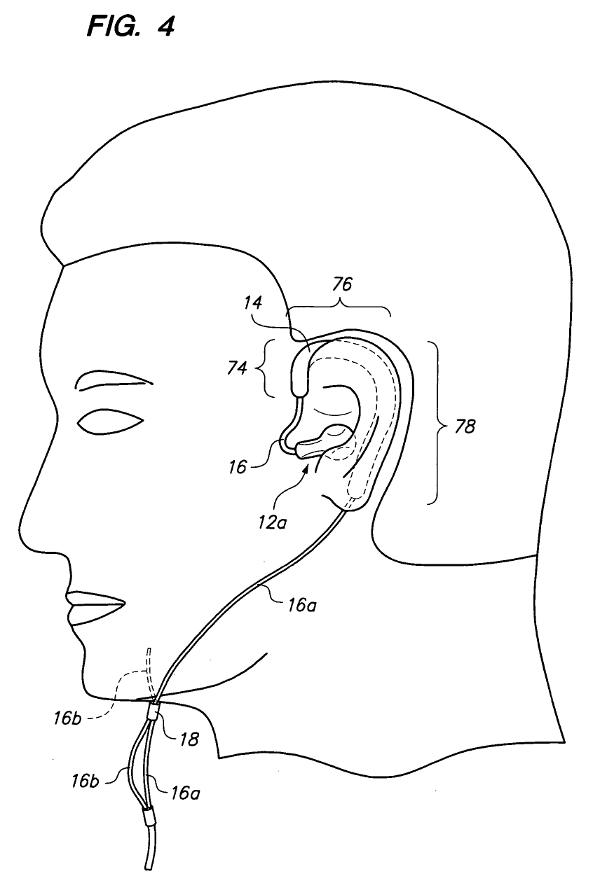

To mount the deformable structure 14 on the ear of the user, the deformable structure 14 is placed around the user's ear, as shown in FIG. 4. The frontal portion 74 of the deformable structure 14 is positioned in front of the user's ear, the upper portion 76 of the deformable structure 14 is placed above the user's ear, and the rear portion 78 of the deformable structure 14 is placed behind the user's ear. The user squeezes the deformable structure 14 such that the deformable structure 14 slightly presses against the user's ear. This is the closed position of the deformable structure 14. The earbud 12 is then inserted into the ear canal of the user.

After the deformable structures 14 are engaged about the user's ears and the earbuds 12 are inserted into the ear canals of the user, the electrical wires 16 hang downward towards the user's chin and in front of the user's chest. The left and right electrical wires 16a, 16b may be frictionally received into the cinching device 18 (see FIGS. 1 and 4). The cinching device 18 may be slid upward so as to tighten the electrical wire 16 against the side of the user's face and below the lower jaw of the user. The deformable structures 14 hook over the user's ears and the cinching device 18 applies tension to the electrical wires 16.

More particularly, the cinching device 18 has two apertures. A left aperture frictionally receives the left electrical wire 16 such that the left electrical wire 16a may frictionally slide through the left aperture of the cinching device 18. Likewise, the right electrical wire 16b may frictionally slide through a right aperture of the cinching device 18. With the deformable structures 14 secured to the ears of the user, the cinching device 18 may be drawn closer to the deformable structures 14 or cinched against the lower jaw of the user, as shown in FIG. 4. Accordingly, the deformable structures 14 and the cinching device 18 provides tension in the electrical wires 16 such that despite movement of the user's head required in the physical activity, the earphone 10 will not be dislodged off of the user's head or the earbuds 12 out of the user's ear canal.

Midway from the length of the electrical wires 16, the electrical wires 16 may be joined at a mid length of the electrical wires 16. The distal ends of the electrical wires 16 may be attached to a jack 20.

An adjustable clip 82 (see FIG. 1) may also be attached to the electrical wire 16 such that the electrical wire 16 may be secured to the clothing of the user. This prevents the electrical wire from swinging around interfering with the user's requirement movement.

The friction fit between the earbud 12 and the user's ear provides a first level of securing the earphone 10 to the user's head and ear. The deformable structure 14 provides a second level of securement of the earphone 10 to the user's head and ear. Additionally, the cinching device 18 along with deformable structures 14 provide a third level of securement of the earphone 10 to the user's head.

The earphone is comfortable to wear due to the deformability of the deformable structure 14. Additionally, the user may be provided with different size sets of ear interface members such that the user may select the most comfortable set. The earphone is also comfortable to wear because even if the ear bud were to be dislodge from the ear of the user. The ear buds are easy to find. The reason is that the ear bud is connected to the deformable structure on a short tether (i.e., the electrical wire). As such, the user need only feel around his/her ear to find the ear bud. The user does not have to visually look for the ear bud when dislodged.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An earphone securable to an ear of a human for listening to audio sounds via an audio producing machine, the earphone comprising:
a deformable structure sized and configured to fit at least partially about the human ear, the deformable structure being deformable between an opened position and a closed position, the opened position of the deformable structure permits the earphone to be removed from the human ear or disposed about the human ear, the closed position of the deformable structure secures the earphone to the human ear such that the person may simultaneously engage in a physical activity and listen to audio sounds;
an electrical wire attached to the deformable structure, the electrical wire defining a first distal portion and a second distal portion;
an earbud sized and configured to snugly fit within an ear canal of the human ear, the earbud having a speaker disposed within the earbud which the speaker is electrically connected to the first distal portion of the electrical wire; and
a plug sized and configured to fit an output jack of the audio producing machine, the plug being electrically connected to the second distal portion of the electrical wire.

2. The earphone of claim 1 wherein the deformable structure has a conduit sized and configured to frictionally receive the electrical wire therethrough.

3. The earphone of claim 1 wherein a length between the earbud and deformable structure may be sufficient long for the earbud to be insertable into the ear but short enough for the human to easily find the earbud if dislodged.

4. The earphone of claim 1 wherein the deformable structure has a J shape configuration.

5. The earphone of claim 1 wherein the deformable structure defines a first portion, second portion and a third portion, the first, second and third portions being sized and configured such that the first portion may rest in front of the ear, the second portion may rest on top of the ear and the third portion may rest in back of the ear.

6. The earphone of claim 1 wherein the earbud has a plurality of ridges extending radially outwardly, the ridges being sized and configured to snugly fit within the ear.

7. The earphone of claim 1 wherein the deformable structure is malleable.

8. The earphone of claim 1 wherein the deformable structure is biased to the closed position.

9. The earphone of claim 1 wherein the earbud comprises a rigid housing and flexible ear interface member, the ear interface member being removably attachable to the rigid housing such that ear interface members optimally sized to the human's ear may be attached to the rigid housing by the human.

10. The earphone of claim 9 wherein the ear interface member may be provided in a small size, medium size and a large size.

11. The earphone of claim 9 wherein the rigid housing has a distal tip portion having a bulbous configuration.

12. The earphone of claim 11 wherein the distal tip portion has a stepped configuration.

13. The earphone of claim 11 wherein the flexible ear interface member has a cavity sized and configured to receive the distal tip portion.

14. An earphone securable to an ear of a person for listening to audio sounds via an audio producing machine, the earphone comprising:
left and right earbuds sized and configured to fit within the left and right ears;
left and right hook shaped structures size and configured to hang on the left and right ears, respectively;
left and right electrical wires electrically connected to left and right earbuds, respectively and connectable to an output jack of the audio producing machine;
a cinching device comprising left and right apertures sized and configured to frictionally receive the left and right electrical wires, respectively, the cinching device traversable between a proximal position and a distal position;
wherein the left and right hook shaped structures may be disposed over the left and right ears and the cinching device disposed under the person's jaw, the cinching device being traversable toward the proximal position until the earphone is secured to the head of the person.
